(19) United States
(12) Patent Application Publication
(10) Pub. No.: US 2009/0168734 A1
(43) Pub. Date: Jul. 2, 2009

(54) BROADBAND WIRELESS ACCESS APPARATUS AND FREQUENCY INTERFERENCE AVOIDING METHOD THEREOF

(75) Inventor: Yong-Sang Cho, Seoul (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LG ELECTRONICS INC.

(21) Appl. No.: 12/273,398

(22) Filed: Nov. 18, 2008

(30) Foreign Application Priority Data
Dec. 28, 2007 (KR) 10-2007-0140933

(51) Int. Cl. H04W 88/02

(52) U.S. Cl. 370/338

(57) ABSTRACT

A broadband wireless access apparatus that can be separated to improve its portability and mobility and its frequency interference avoiding method are disclosed. The broadband wireless access device includes: a main body unit having a power and multi-network management function; an antenna cradle rotatably combined with the main body unit; and a detachable (separation-type) wireless access device detachably attached to the antenna cradle.

### CROSS REFERENCE TO RELATED APPLICATIONS

The present application claims priority to Korean Application No. 10-2007-0140933 filed in Korea on Dec. 28, 2007, the entire contents of which is hereby incorporated by reference in its entirety.

### BACKGROUND OF THE INVENTION

1. Field of the Invention

The present invention relates to a broadband wireless access apparatus that can be separated to improve its portability and mobility and its frequency interference avoiding method.

2. Description of the Related Art

Recently, user demands for a broadband wireless LAN service or a mobile Internet service allowing data communication by a connection to the Internet and long distance communication such as a mobile phone are on the rise.

For example, WiBro (Wireless Broadband) is a mobile Internet service, which is advantageous in terms of unit costs in spite of its drawbacks that the number of base stations (about 1.2 to 1.5 times) or movable speed (about 60 km) is relatively bad compared with the EV-DO (Evolution Data Only) service currently available for the CDM mobile phone.

Wimax, started from a somewhat different phase from the WiBro, is a service aimed to overcome the shortcomings of the existing wireless LAN that there is much limitation in availability because of its short arrival distance of tens of meters although a large number of access points are installed. In this sense, the Wimax may be considered a wireless LAN that has a hugely extended distance and speed.

In order to stably use the mobile Internet service with quality wireless performance indoors, a broadband wireless access device having high wireless performance should be installed. However, the related art broadband wireless access device as shown in FIG. 1 is too high and voluminous overall to be stably used. In addition, because it has been developed as a fixed device, its portability and mobility are not good.

FIG. 1 is a perspective view of the related art broadband wireless access device, which includes a main body 110 of the broadband wireless access device, various types of antennas 120 combined with the main body 110, and a supconnection terminal130 for making the main body stand.

The main body 110 of the broadband wireless access device includes a connection terminal111 formed at one side thereof to connect a power source and a fixed line network, and a terminal 113 formed at another side to connect a short range wireless communication antenna 112 and a terminal 114 formed at still another side to connect a plurality of broadband wireless communication antennas. As the broadband wireless communication antennas, a plurality of straight dipole antennas 121 may be connected or a box-shaped directional antenna 122 may be connected.

As shown in FIG. 1, when the antenna is combined to the related art broadband wireless access device, the height is increased, degrading the stability and increasing the overall volume to cause restriction in the mobility and portability.

### SUMMARY OF THE INVENTION

Accordingly, one object of the present invention is to address the above-noted and other problems.

Another object of the present invention is to provide an indoor broadband wireless access device (i.e., customer premise equipment) having a main body in the shape of a supconnection terminal(stand) allowing an antenna to be combined thereto.

Still another object of the present invention is to provide a detachable wireless access device that can be detachably attached to an indoor broadband wireless access device.

Yet another object of the present invention is to provide a method for providing or performing two wireless access services using close frequency bands in a single apparatus without causing a mutual frequency interference.

To achieve these and other advantages and in accordance with the purpose of the present invention, as embodied and broadly described herein, the present invention provides in one aspect a broadband wireless access device including: a main body unit having a power and multi-network management function; an antenna cradle rotatably combined with the main body unit; and a detachable (separation-type) wireless access device detachably attached to the antenna cradle.

The main body unit may be configured to supply power to the antenna cradle and the detachable wireless access device, connect and manage a plurality of Ethernet lines including a short-range wireless communication (near field communication) service, provide a VoIP call service by connecting an analog call, and control an overall operation of the broadband wireless access device in association with the respective elements and the detachable wireless access device.

The antenna cradle may include: a plurality of transmission/reception antennas for broadband wireless communication; a plurality of switches that selectively switch switching the antennas; a plurality of band filters that filter broadband radio signals transmitted/received via the antennas; a high output power amplifier that amplifies a broadband radio signal to be outputted to a transmission antenna among the antennas; and a plurality of connection terminals that connect the detachable wireless access device, an RF signal path and a control signal.

The detachable wireless access device may include: a plurality of transmission/reception antennas that transmit/receive signals filtered by a plurality of band filters; a power amplifier that amplifies a broadband radio signal to be transmitted to a transmission antenna; an RF signal processing unit that processes a broadband radio signal transmitted/received via the antennas; and a broadband communication controller that controls the signal processing operation and controls an operation for a wireless radio access by communicating with the main body unit and the antenna cradle.

The indoor broadband wireless access device according to the present invention has the advantage that because the main body unit is configured as the shape of a supconnection terminal that can be combined with antennas, the height and volume can be reduced and the stability can be improved.

In addition, because the detachable wireless access device can be attached to or detached from the indoor broadband wireless access device, the mobility and portability can be improved.

Moreover, when two types of wireless access services using close frequency bands are performed, they are not interfered by mutual frequencies, increasing the utilization of frequency resources.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by illustration only, and thus are not limitative of the present invention, and wherein:

FIG. 1 is a perspective view of a broadband wireless access device according to the related art;

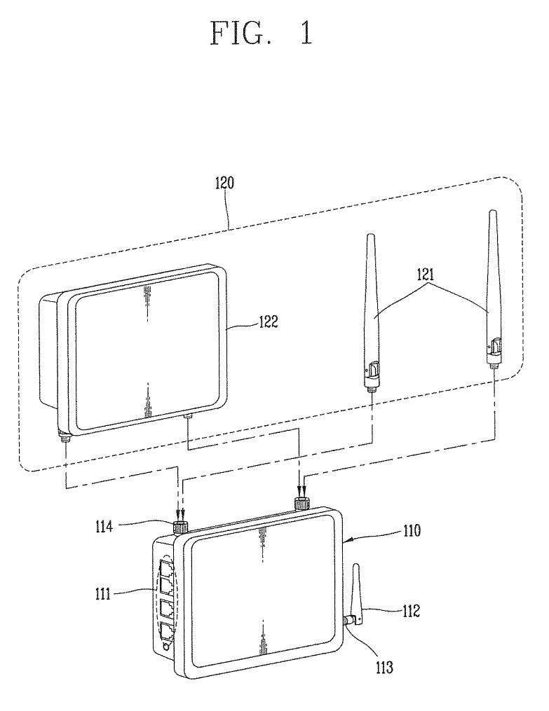

FIG. 2A is a front perspective view of a broadband wireless access device according to an embodiment of the present invention;

FIG. 2B is a rear perspective view of the broadband wireless access device according to an embodiment of the present invention;

FIG. 3 is a block diagram showing an internal configuration of the broadband wireless access device according to an embodiment of the present invention;

FIG. 4 is a view for showing a combination of the broadband wireless access device and a detachable wireless access device according to an embodiment of the present invention;

FIG. 5 is a view showing a configuration of a connection terminal for connecting the broadband wireless access device and the detachable wireless access device according to an embodiment of the present invention;

FIGS. 6A and 6B are flow charts illustrating the process of a method for positively avoiding an interference of the broadband wireless access device according to an embodiment of the present invention; and

FIGS. 7A and 7B are flow charts illustrating the process of a method for negatively avoiding an interference of the broadband wireless access device according to an embodiment of the present invention.

### DETAILED DESCRIPTION OF THE INVENTION

Reference will now be made in detail to the preferred embodiments of the present invention, examples of which are illustrated in the accompanying drawings. In describing the present invention, if a detailed explanation for a related known function or construction is considered to unnecessarily divert the gist of the present invention, such explanation has been omitted but would be understood by those skilled in the art. In describing the present invention with reference to the accompanying drawings, the like reference numerals are used for the elements performing the like function.

The mobile terminal according to an embodiment of the present invention will now be described in detail with reference to the accompanying drawings.

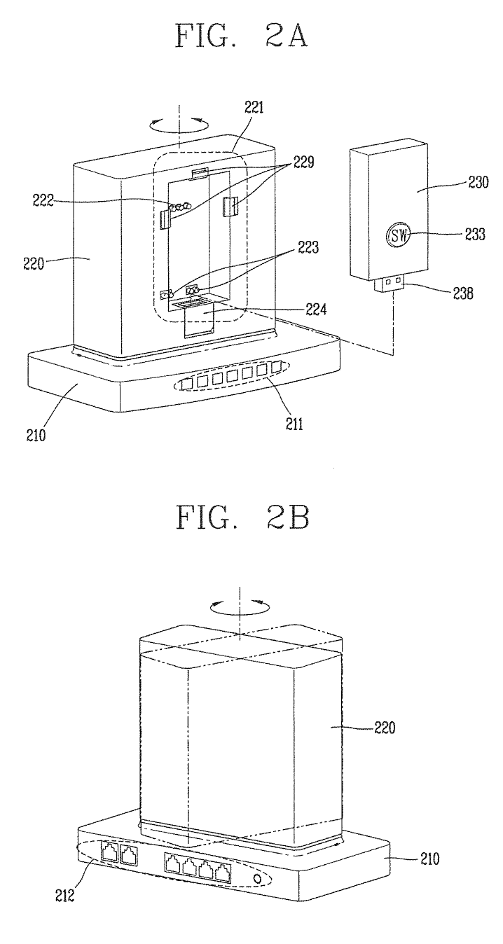

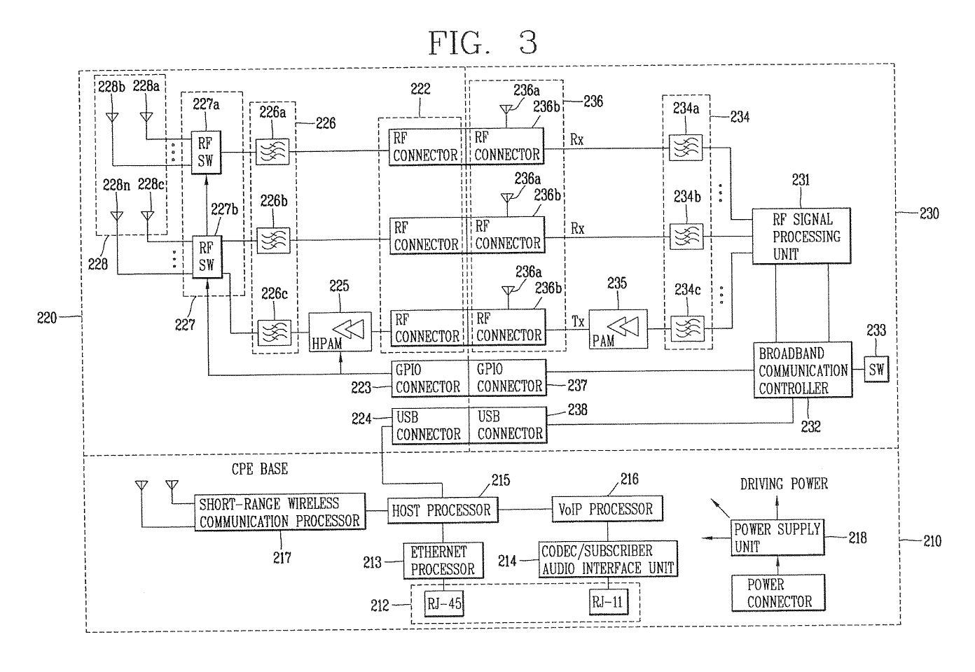

FIG. 2A is a front perspective view of a broadband wireless access device according to an embodiment of the present invention, and FIG. 2B is a rear perspective view of the broadband wireless access device according to an embodiment of the present invention.

As shown in FIGS. 2A and 2B, the broadband wireless access device according to an embodiment of the present invention includes: a main body unit 210 configured as a supconnection terminal (pedestal, prop), an antenna cradle 220 rotatably combined on the main body unit 210, and a detachable wireless access device 230 that can be attached to or detached from the antenna cradle 210.

The main body unit 210, the antenna cradle 220, and the detachable wireless access device 230 are not limited to the configuration as shown in FIGS. 2A and 2B but may have various configurations.

The main body unit 210 includes an indicator unit 211 formed on a front side and indicating various operation states, and an interface unit 212 formed on a rear side and connecting an operation power source and a plurality network lines and telephone lines.

The antenna cradle 220 includes a plurality of antennas therein, and a plurality of switches, a filter, a power amplifier, or the like for selecting an antenna to transmit/receive a signal. The antenna cradle 220 also includes a coupling unit 221 formed on a front surface (or rear surface) to couple the detachable wireless access device 230. Further, the antenna cradle 220 may be configured to be rotatable 180° clockwise or counterclockwise in order to change an antenna direction angle.

The coupling unit 221 may have a recess form so that although the detachable wireless access device 230 is attached thereto, it may not be protruded from the antenna cradle 220. In this case, the recess may be configured according to the shape of the wireless access device 230, and in order to easily attach or detach the detachable wireless access device 230, a recess to allow the user's finger to be received therein may be formed at an upper portion or left/right portion of the recess in which the wireless access device is combined. In addition, the coupling unit 221 includes a locking unit 229 in order to firmly fix the detachable wireless access device 230 so that the detachable wireless access device 230 cannot be shaken or released, when the detachable wireless access device 230 is attached to the antenna cradle 220.

The coupling unit 221 may include a plurality of connection terminals or connectors 222 to 224 for electrically connecting the detachable wireless access device 230 to the antenna cradle 220 and the main body unit 210. The connection terminals (or connectors) may include a connector 224 in the same of a USB connector. The connector 224 in the shape of the USB connector may be configured to be rotated at a certain angle toward a front side of the antenna coupling unit 220 to allow the detachable wireless access device 230 to be easily attached or detached.

The functional operation of the broadband wireless access device will now be described.

First, when the detachable wireless access device 230 is attached to the antenna cradle 220, the antenna cradle 220 interrupts an antenna connection within the detachable wireless access device 230. This is because an internal mobile switch (not shown of the antenna cradle 220 switches an RF signal path from an internal antenna 236a of the detachable wireless access device 230 to an antenna 228 of the antenna cradle 220. Accordingly, the detachable wireless access device 230 is connected with the internal antenna 228 of the antenna cradle 220 via the RF path.

The antenna cradle 220 includes a plurality of antennas 228a to 228n, so it can obtain a space diversity gain according to switching of the antennas, a high output by the power amplifier and effectively remove a signal interference by a short-range wireless LAN (e.g., WiFi) provided in the main body unit 210 via a BPF (Band Pass Filter or the like.

When the detachable wireless access device 230 is attached on the antenna cradle 220, the main body unit 210 may perform data communication by controlling a host processor 215. in this case, the data communication method follows a radio communication scheme provided in the detachable wireless access device 230 that may include a broadband radio communication scheme including WiMax, OFDM (Orthogonal Frequency Division Multiplexing) method, or a compatible method.

The detachable wireless access device 230 may include a power switch 233 provided on a surface exposed when the detachable wireless access device 230 is attached on the antenna cradle 220. The power switch 233 may have an indicator function based on a backlight and display a state when power is applied or when the power switch operates, as a backlight. Of course, the indicator may use a light emitting element and may be configured at a different position from the position as shown in the drawing.

The power switch 233 performs a switching function of resetting, a network connection, a network release and a power ON/OFF.

For example, according to the switching method, hardware of the detachable wireless access device 230 may be reset by pressing the power switch 233 once for a short time.

When the detachable wireless access device 230 is connected with the main body unit 210, the main body unit 210 automatically recognizes the detachable wireless access device 230 to perform initialization. When the initialization operation is completed, the detachable wireless access device 230 is available for being connected with a wireless network, and at this time, the power switch 233 may indicate the corresponding state via the indicator.

If the power switch 233 is pressed for more than a certain time, power of the detachable wireless access device 230 may be turned off. In this case, before the power is turned off, the broadband communication controller 232 of the detachable wireless access device transmits a connection release message to a base station. A host processor 215 of the main body unit 210 may check the turn-off state of the detachable wireless access device 230 and indicate the fact that the detachable wireless access device 230 does not operate via the indicator unit 211.

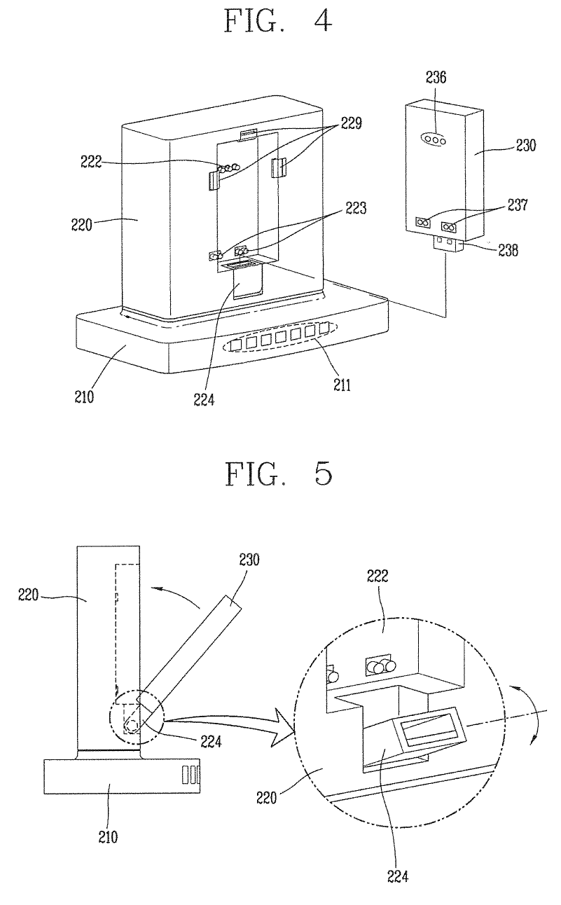

FIG. 3 is a block diagram showing an internal configuration of the broadband wireless access device according to an embodiment of the present invention.

With reference to FIG. 3, the main body unit 210 includes a power supply unit 218 that receives external power and supplies operation power to the antenna cradle 220 and the detachable wireless access device 230, an Ethernet controller 213 that manages a connector RJ-45 for connecting a plurality of Ethernet lines and the plurality of Ethernets, a codec/subscriber audio interface unit 214 that connects a connector an RJ-11 for connecting a telephone line and a telephone to a computer or a VoIP terminal to allow performing of a high quality VoIP call, a VoIP processor 216 that performs a VoIP service via the codec/subscriber audio interface unit 214, a short-range wireless communication processor 217 that performs short-range wireless communication service including a WLAN or WiFi, and a host processor 215 that controls the overall operation of the broadband wireless access device in association with the processors and the detachable wireless access device 230.

Here, if the processor is implemented as hardware, it may be implemented by using at least one of electric units such as ASICs (application specific integrated circuits), DSPs (digital signal processors), DSPDs (digital signal processing devices), PLDs (programmable logic devices), FPGAs (field programmable gate arrays), processors, controllers, micro-controllers, and microprocessors.

The antenna cradle 220 includes an antenna unit 228 including a plurality of transmission/reception antennas 228a to 228n for broadband wireless communication, an antenna switching unit 227 including a plurality of switches 227a and 227b that selectively switch the antennas of the antenna unit 228 under the control of the broadband communication controller 232 of the detachable wireless access device 230, a filter unit 226 including a plurality of band filters for canceling noise from an RF signal transmitted to/received from an antenna connected via the antenna switching unit 227, a high output power amplifier 225 that amplifies an RF signal to be outputted to a transmission antenna among the antennas, and a plurality of connection terminals 222 to 224 that connect the antenna unit 228 and the detachable wireless access device 230 to establish an RF signal path and a control signal path.

The antenna cradle 220 includes the plurality of (N number of) high gain antennas 228a to 228n, and the high output power amplifier 225 for amplifying and outputting a transmission signal when connected with the detachable wireless access device 230.

The antenna cradle 220 further includes band filters 226a to 226c having high skirt characteristics at every RF signal path to restrain an interference by a short-range radio signal (WiFi) from the main body unit. For example, a stop band of the respective band filters 226a to 226c may be 2.4 GHz to 2.472 GHz or 2.4 GHz to 2.482 GHz, and a pass band of the respective band filters 226a to 226c may be 2.496 GHz to 2.69 GHz.

In order to prevent degradation of performance of the short-range wireless communication device due to an RF signal of the detachable wireless access device 230, a stop band of a band filter (not shown) included in the short-range wireless communication device in the main body unit 210 may be 2.4 GHz to 2.472 GHz or 2.4 GHz to 2.482 GHz.

When the detachable wireless access device 230 is connected to the main body unit 210, in order to prevent degradation of performance of the two devices, the host processor 215 of the main body unit 210 may monitor a usage frequency and a reception packet error rate of the short-range wireless communication processor 217 in the main body unit 210 at certain time intervals. If a usage frequency of the short-range wireless communication processor 217 is 2.472 GHz or 2.482 GHz upon monitoring, the host processor 215 may control the detachable wireless access device 230 to make maximum power transmitted from the antenna cradle lower than a certain level, thereby adjusting a reception packet error rate of the short-range wireless communication processor 217 such that it is lower than a certain level.

If a radio environment of the detachable wireless access device 230 is not good in an area, frequency controlling may be preferentially performed to make the usage frequency of the short-range wireless communication processor lower than 217 2.472 GHz, rather than controlling maximum transmit power of the antenna cradle 220.

When the detachable wireless access device 230 is connected to the antenna cradle 220, an operation of the power amplifier 235 in the detachable wireless access device 230 is changed to a low gain mode in which the power amplifier 235 operates as a pre-amplifier.

Calibration data such as a gain slop and frequency dependency data with respect to the high output power amplifier 225 of the antenna cradle 220 or temperature dependency data may be stored in a memory (not shown) of the main body unit 210 in the process of mass-production, and may be downloaded to a memory (not shown) of the detachable wireless access device 230 during an initialization process performed after the detachable wireless access device 230 is connected to the antenna cradle 220.

The downloaded calibration data may be stored as a separate table different from existing calibration data stored in the memory (not shown) of the detachable wireless access device 230 and may be called to be used only when the detachable wireless access device 230 is connected to the antenna cradle 220 and operates.

The detachable wireless access device 230 is to perform broadband wireless communication while being carried along, and may have a USB connector 238 for an interface with a computer. When the USB connector 238 is connected with the main body unit 210 via the antenna cradle 220, it serves as an interface for establishing a communication and control path with the host processor 215.

The detachable wireless access device 230 includes an antenna unit 236 including a plurality of transmission/reception antennas for broadband wireless communication, a filter unit 234 including a plurality of band filters to cancel noise from a signal transmitted to or received from the antenna unit 236, an RF signal processing unit 231 that processes an RF signal transmitted/received via the antenna unit 236, a broadband communication controller 232 that controls a signal processing operation via the RF signal processing unit 231 and communicates with the main body unit 210 and the antenna cradle 220 to perform a broadband wireless access operation, and a power amplifier that amplifies a signal to be outputted via a transmission antenna of the antenna unit 236.

When the detachable wireless access unit 230 is connected to the antenna cradle 220, a signal path between the antennas 236a and the RF signal processing unit 231 in the detachable wireless access device 230 is cut off, and instead, an RF signal path is connected between an antenna provided in the antenna cradle 220 and the RF signal processing unit 231 via an RF connector 236b.

The broadband communication controller 232 of the detachable wireless access device 230 may control the high output power amplifier 225 or the antenna switching unit 227 of the antenna cradle 220 via a particular communication port (e.g., a GPIO (General Purpose Input/Output) port), for which the broadband communication controller 232 may have a connector (e.g., a GPIO connector 237). In addition, the broadband communication controller 232 may input/output a signal, which is to be processed by the RF signal processing unit 231 via the USB connector 238, to or from the main body unit 210 or a computer to which the detachable wireless access device 230 is connected.

The detachable wireless access device 230 may include the power switch 233 to turn on or off power or release a connection to the main body unit 210. When a connection with the main body unit is released by using the power switch 233, the indicator unit 211 attached on the front side of the main body unit 210 may indicate an indicator indicating an operation state of the detachable wireless access device 230 as an OFF state.

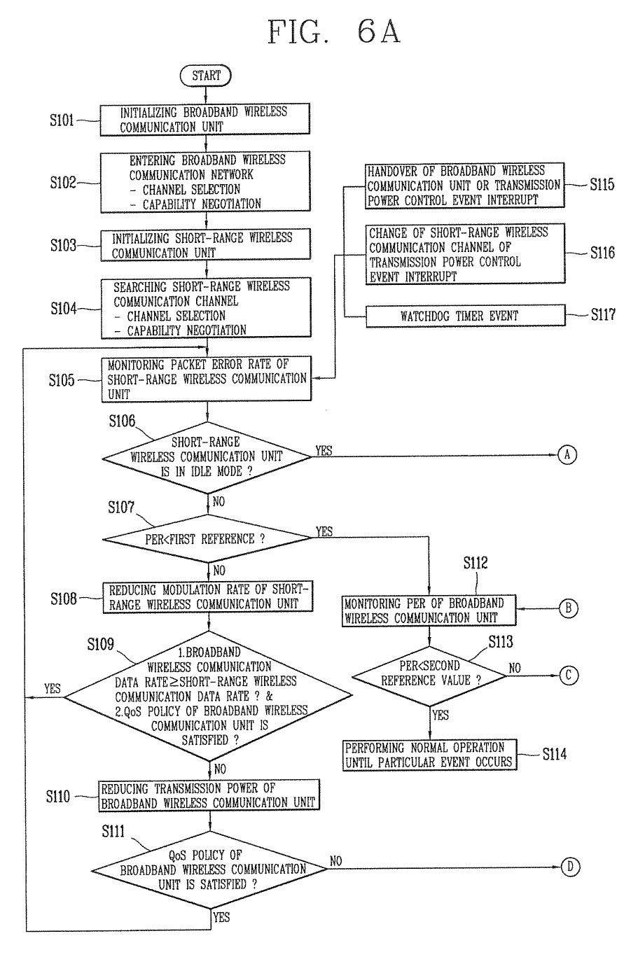

FIG. 4 is a view for showing a combination of the broadband wireless access device and a detachable wireless access device according to an embodiment of the present invention.

As shown in FIG. 4, the coupling unit 221 includes the plurality of connection terminals 222 to 224 for forming a communication path when the detachable wireless access device 230 is coupled, and may include the locking unit 229 at one side thereof in order to firmly fix the detachable wireless access device 230.

The detachable wireless access device 230 includes the terminals 236 to 238 corresponding to the connection terminals 222 to 224. The connection terminals of the antenna cradle 220 may be a mail type terminals while the connection terminals of the detachable wireless access device 230 may be female type terminals, but the types of the respective terminals are not limited.

Here, among the connection terminals, the USB type terminals 224 and 238 are to form a communication path between the main body unit 210 and the detachable wireless access device 230, the RF signal connection terminals 222 and 236 are to form an RF signal path between the detachable wireless access device 230 and the antenna cradle 220, and the antenna cradle control terminals 223 and 227 are to form a control path for controlling switching of the antennas provided in the antenna cradle or power amplifier in the detachable wireless access device 230.

When the RF signal connection terminals 222 and 236 are connected, the connection between the antenna 236a and the RF connector 236b provided in the detachable RF connection device 230 is cut off and an RF signal path is formed with the antenna unit 228 provided in the antenna cradle 220. In this case, the number of RF signal connection terminals 222 and 236 follows the number of transmission paths and reception paths provided in the detachable wireless access device 230.

The antenna cradle control terminals 223 and 227 are for switching the antennas provided in the antenna cradle 220. The USB communication method, according to which the main body unit 210 and the detachable wireless access device 230 are connected, can hardly perform controlling sensitive to timing, so the main body unit does not control the antenna switching but the broadband communication controller 232 controls the antenna switching.

As the RF signal connection terminals 222 and 236, RF switch connector elements that are typically applied for mobile terminals may be used. As the antenna cradle control terminals 223 and 227, a protruded type metal terminal such as a plate spring or a pogo-pin may be used at the cradle side, while only a very small metal terminal that can operate in contact with the terminals of the cradle can be applied to the detachable wireless access device 230 of the counterpart.

If connections between the RF signal connection terminals 222 and 236 and the antenna cradle control terminals 223 and 227 are unstable, noise would be possibly included, so the locking unit 229 may be provided for a firm fixing. The locking unit 229 may be provided at both sides of the coupling unit 221 or only at an upper side of the coupling unit 221. For example, the locking unit 229 may employ a lock rob method.

The above-described positions, shapes and roles of the connection terminals have been described only for explanation and may not be limited thereto.

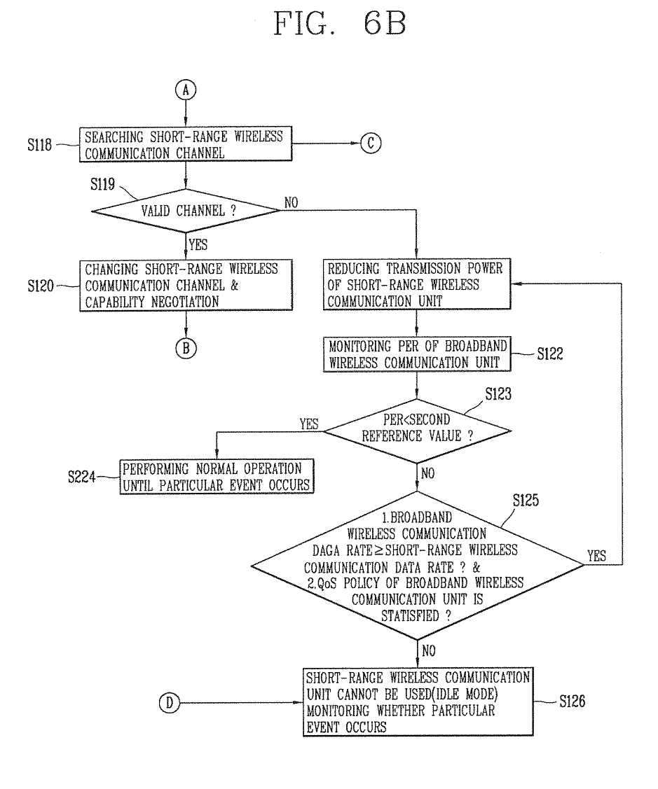

FIG. 5 is a view showing a configuration of a connection terminal for connecting the broadband wireless access device and the detachable wireless access device according to an embodiment of the present invention.

As shown in FIG. 5, in order to attach the detachable wireless access device 230 to the antenna cradle 220 or detach the detachable wireless access device 230 from the antenna cradle 220, the USB connection terminal 224 may be configured to be rotated at a certain angle inwardly or outwardly (or in both forward and backward directions) of the antenna cradle 220 so as to be led in or out (i.e., drawn in or out). In addition, the USB connection terminal 224 as shown in FIG. 5 has such a structure allowing the detachable wireless access device 230 to be combined at an upper side thereof, but may have a structure allowing the detachable wireless access device 230 to be combined at the side.

For example, one side of the USB connection terminal 224 of the antenna cradle 220 is rotated outwardly at a certain angle so as to be drawn out to insert the detachable wireless access device 230 therein, and then, the detachable wireless access device 230 inserted in the USB connection terminal 224 is drawn in so as to be combined and then fixed by using the locking units 229.

Meanwhile, if the broadband wireless access device and the detachable wireless access device are combined to use a broadband wireless communication frequency and a short-range wireless communication frequency are used, because the two frequency usage bands are close, a mutual frequency interference may occur. Thus, although the filter having the high skirt characteristics as mentioned above is employed to avoid such interference, if the interval between the two frequencies narrows, their mutual interference could not be completely canceled with the filter, and in addition, the degree of mutual interference may vary according to the tolerance of the filter and a temperature change.

Thus, the present invention further provides a method for complement an interference avoidance by the filter. The frequency interference avoiding method may be performed by using one of the plurality of processors.

The following description will be based on the assumption that the wireless access device uses both a wireless wide area network (WWAN) including WiMAX and a wireless local area network (WLAN) or personal area network (PAN) including Wi-Fi. In addition, the detachable wireless access device (that can be referred to as ‘broadband wireless communication unit’ or ‘first wireless communication unit’, hereinafter) may perform connection (access) of the WWAN, and the main body unit (referred to as ‘local area wireless communication unit’ or ‘second wireless communication unit’, hereinafter) may perform the local area wireless communication

The interference avoiding method according to the present invention may be divided into a positive method in which an optimum channel without an interference is searched according to an environment setting or menu selection to avoid an interference and a negative method in which if an interference occurs, local area wireless communication is temporarily paused to avoid interference, and performed.

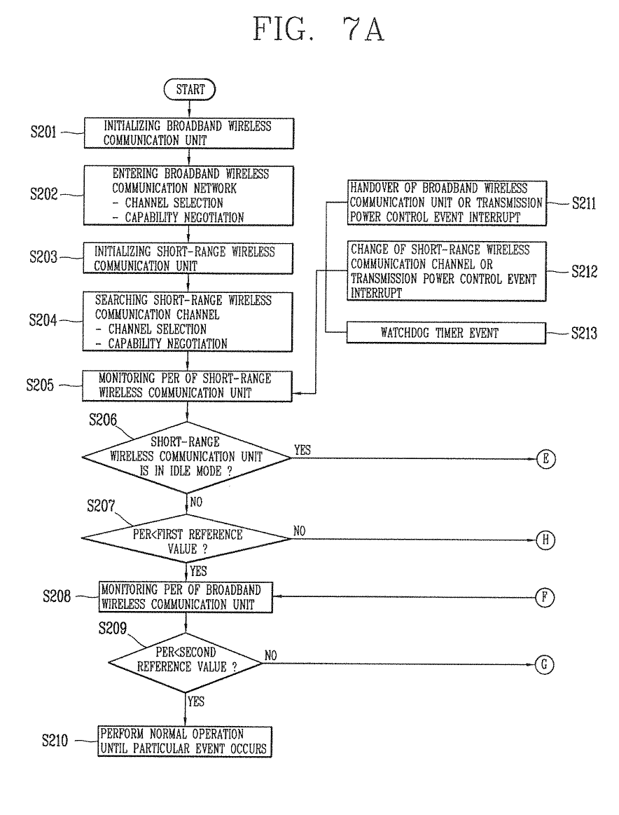

FIGS. 6A and 6B are flow charts illustrating the process of a method for positively avoiding an interference of the broadband wireless access device according to an embodiment of the present invention.

As shown in FIGS. 6A and 6B, when power is applied to the broadband wireless access device, the broadband wireless communication unit is initialized (S101) and a channel selection and capability negotiation with a base station is performed (S102). Likewise, the local area wireless communication unit is initialized, and a channel selection and capability negotiation with a base station is performed (S103, S104). At this time, the channel is selected by the local area wireless communication unit by giving priority to a lower frequency in order to avoid a frequency interference section.

When the initialization is completed, each wireless communication unit may monitor a data packet error rate (PER) of a selected channel to check whether the selected channels have mutually interfered with each other. Namely, if the data PER is greater than a particular reference value (minimum spec), it may be determined that the channels mutually interfere with each other, and in this case, a channel having a data PER smaller than the particular reference value should be searched to replace the selected channel.

The method for searching and changing channels will be described in detail as follows.

First, if the local area wireless communication unit is not in an idle mode (S106), the data PER is monitored. If the data PER is larger than a first particular reference value (S107), a modulation rate of the local area wireless communication unit is reduced to reduce the data rate (S108).

And then, it is checked whether the data rate of the broadband wireless communication unit is larger than or the same as that of the local area wireless communication unit in the current channel, and also it is checked whether the current channel satisfies the QoS policy of the data of the broadband wireless communication unit (S109). If the two conditions are all met in step S109, steps S105 to S109 are repeatedly performed, and any one of the conditions is not met, the step S110 is performed.

The transmit power of the broadband wireless communication unit is gradually reduced stepwise, and then, it is checked whether the current channel satisfies the data QoS policy of the broadband wireless communication (S111). If the current channel satisfies the data QoS policy of the broadband wireless communication unit, steps S105 to S109 are repeatedly performed.

If the current channel does not satisfy the data QoS policy of the broadband wireless communication unit in step S111, step S126 is performed. Namely, because the local area wireless communication unit cannot be used until before a communication environment is changed as a particular event occurs, it is monitored as to whether a particular event occurs (S126).

The particular event includes an event that the broadband wireless communication unit performs handover or that transmit power is controlled (S115), an event that a channel of the WLAN is changed or transmit power is controlled (S116), or a periodical interrupt check event by a watch dog timer (S117).

If the data PER of the local area wireless communication unit is smaller than the first particular reference value in S107, a PER of the broadband wireless communication unit is monitored in S112. It is checked whether the PER of the broadband wireless communication unit is lower than a second particular reference value in S113.

If the PER of the broadband wireless communication unit is smaller than the second particular reference value, the broadband wireless communication unit and the local area wireless communication unit normally operate without a mutual interference until before the particular event occurs in S114.

The method for searching a channel by the local area wireless communication unit if the data PER of the broadband wireless communication unit is not smaller than the second particular reference value in S113 will now be described.

In this case, channel searching may be immediately performed if the local area wireless communication unit is in an idle mode, and whether or not the local area wireless communication is in the idle mode is determined in step S106.

If a local area wireless communication channel is searched in S118, it is checked whether the searched channel is a valid channel in S119. If the searched channel is a valid channel, the current local area wireless communication channel is changed to the searched valid channel and a capability negotiation with respect to the changed channel is performed. And then, steps S112 and S113 are performed. Steps S118 to S120 may be repeatedly performed according to determinations at the step S113.

If there is no valid channel in the searched channels in S118, the transmit power of the local area wireless communication unit is reduced in S121, and a PER of the broadband wireless communication unit is monitored in S122. It is checked whether the data PER of the broadband wireless communication unit is smaller than the second particular reference value in S123. If the data PER of the broadband wireless communication unit is smaller than the second particular reference value, step S124 is performed. Namely, the broadband wireless communication unit and the local area wireless communication unit normally operate without a mutual interference until before a particular event occurs.

It is checked whether the data rate of the broadband wireless communication unit is larger than or the same as that of the local area wireless communication unit in the current channel, and also it is checked whether the current channel satisfies the QoS policy of the data of the broadband wireless communication unit (S125). If the two conditions are all met in step S125, steps S121 to S125 are repeatedly performed, and any one of the conditions is not met, the step S126 is performed. Namely, because the local area wireless communication unit cannot be used until before a communication environment is changed as a particular event occurs, it is monitored as to whether a particular event occurs (S126).

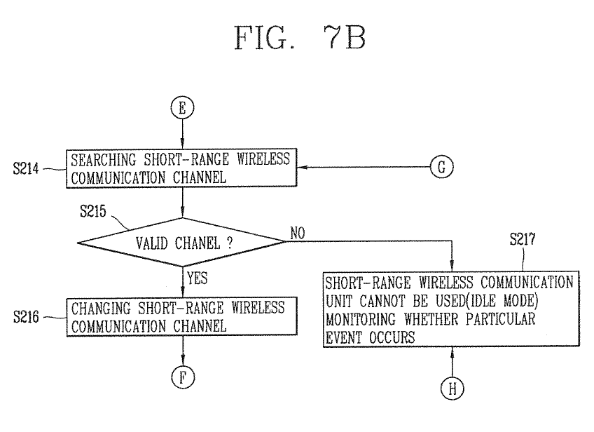

FIGS. 7A and 7B are flow charts illustrating the process of a method for negatively avoiding an interference of the broadband wireless access device according to an embodiment of the present invention.

As shown in FIGS. 7A and 7B, when power is applied to the broadband wireless access device, the broadband wireless communication unit is initialized (S201), selects a channel selection and performs a capability negotiation with the base station (S202). Likewise, the local area communication unit is initialized, selects a channel and performs a capability negotiation (S203, S204). In this case, the channel selected by the local area wireless communication unit is selected by giving priority to channel having a lower frequency to avoid a frequency interference section.

After the initialization is completed, if the local area wireless communication unit is not in an idle mode (S206), a data PER is monitored (S206). If the data PER is larger than a first particular reference value (s207), the local area wireless communication unit cannot be used until before a particular event occurs and a communication environment is changed (S217).

If the data PER of the local area wireless communication unit is smaller than the first particular reference value, a local area wireless communication channel for which the data PER of the broadband wireless communication unit is smaller than the second particular reference value is searched to change the current channel (S208 to S210). Namely, the data PER of the broadband wireless communication unit is monitored (S208). If the data PER is larger than the second particular reference value (S209), a valid channel that is not used by other terminals among a plurality of local area wireless communication channels is searched to replace the current channel (S214 to S216). If there is no valid channel in channel searching (S215), the local area wireless communication unit cannot be used until before a particular event occurs and the communication environment is changed (S217).

The channel searching can be immediately performed if the local area wireless communication unit is in the idle mode (S206). In addition, a channel having a low frequency is preferentially searched, and when the current channel is changed by the searched channel, a capability negotiation is performed on the searched channel (S216).

If a channel of the local area wireless communication unit for which the data PER of the broadband wireless communication unit is smaller than the second particular reference value is searched to replace the current channel, the broadband wireless communication unit and the local area communication unit can normally operate without a mutual interference until before a particular event occurs (S210).

As the exemplary embodiments may be implemented in several forms without departing from the characteristics thereof, it should also be understood that the above-described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

What is claimed is:

1. A broadband wireless access device comprising:
a main body unit having a power and multi-network management function;
an antenna cradle rotatably combined with the main body unit; and
a detachable wireless access device detachably attached to the antenna cradle.

2. The device of claim 1, wherein the main body unit comprises:
a plurality of antennas for local area wireless communication;
an indicator indicating a network connection or an operation state; and
an interface unit connecting a power source, a plurality of network lines and a telephone line.

3. The device of claim 1, wherein the antenna cradle is configured to be rotatable at least 180° clockwise or counterclockwise, and comprises a recessed coupling unit that couples the detachable wireless access device and a locking unit provided on at least one side to fix the detachable wireless access device.

4. The device of claim 3, wherein the coupling unit comprises a plurality of connection terminals that electrically connect the detachable wireless access device and a connector which is rotated at a certain angle centering around one axis so as to be led in or out, wherein the connector comprises a USB connector.

5. The device of claim 4, wherein the connection terminal of the antenna cradle are mal type terminals, and connection terminals of the detachable wireless access device are female type terminals.

6. The device of claim 1, wherein the detachable wireless access device comprises a power switch for resetting, connecting and releasing a network, and turning on or off power.

7. The device of claim 6, wherein the detachable wireless access device comprises an indicator that indicates a network connection or an operation state and is implemented in a backlight type at the power switch.

8. The device of claim 1, wherein the main body unit comprises:
an Ethernet controller that connects and manages a plurality of ethenet lines;
a VoIP processor that performs a local area wireless communication service; and
a host processor that controls an overall operation of a broadband wireless access device in association of each element and the detachable wireless access device.

9. The device of claim 1, wherein the antenna cradle comprises:
a plurality of transmission/reception antennas for broadband wireless communication;
a plurality of switches that selectively switch the antennas;
a plurality of band filters that filter the transmitted/received broadband radio signals; and
a high output power amplifier that amplifies a broadband radio signal to be outputted to the transmission antenna.

10. The device of claim 1, wherein the detachable wireless access device comprises:
a plurality of transmission/reception antennas for a broadband wireless communication service;
a plurality of band filters that cancel noise of the broadband radio signal;
an RF signal processing unit that processes the transmitted/received broadband radio signal; and
a broadband communication controller that controls each element and controls an operation for a broadband wireless communication service by communicating with the main body unit and the antenna cradle.

11. The device of claim 10, wherein when the detachable wireless access device is connected to the antenna cradle, a signal path is switched to receive a broadband radio signal via an antenna provided in the antenna cradle.

12. The device of claim 10, wherein the broadband communication controller control a power amplifier or an antenna switch in the antenna cradle and provides control to input/output a signal to be processed in the RF signal processing unit to/from the main body unit.

13. The device of claim 9, wherein the band filters of the antenna cradle are high skirt band filters having a stop band of 2.4 GHz to 2.472 GHz and a pass band of 2.496 GHz to 2.69 GHz.

14. The device of claim 10, wherein when the detachable wireless access device is connected to the antenna cradle, the power amplifier of the detachable wireless access device is changed to operate in a low gain mode and operates as a pre-amplifier.

15. The device of claim 10, wherein if power of the detachable wireless access device is turned off, the broadband communication controller transmits a connection release message to the host processor of the main body unit, and accordingly, the host processor of the main body unit indicates that the detachable wireless access unit does not operate on an indicator unit.

16. The device of claim 10, wherein when the detachable wireless access device is combined to the antenna cradle, the broadband communication controller downloads correction data including information about a gain slop a frequency deviation and temperature deviation from the main body unit, and controls the power amplifier or the antenna switch by using the correction data.

17. A method for avoiding a frequency interference of a broadband wireless access device in using a local area wireless communication signal and a broadband wireless communication signal whose frequency bands are close, comprising:
searching a local area wireless communication channel having a data packet error rate of a broadband wireless communication signal smaller than a particular reference value and setting the same; and
maintaining the set channel and performing communication if the data packet error rate of the set local area wireless communication channel is smaller than the particular reference value.

18. The method of claim 17, further comprising:
If the data packet error rate of the set local area wireless communication channel is greater than the particular reference value, adjusting a modulation rate of the local area wireless communication unit or transmit power of the broadband wireless communication unit such that the data error rate becomes smaller than the reference value.

19. The method of claim 18, wherein the modulation rate of the local area wireless communication unit is gradually reduced stepwise until the data rate of the broadband wireless communication unit becomes smaller than that of the local area wireless communication unit or until the data rate of the broadband wireless communication unit does not satisfy a data QoS policy of the broadband wireless communication unit.

20. The method of claim 18, wherein if the data rate of the broadband wireless communication unit becomes smaller than the data rate of the local area wireless communication unit or if the data rate of the broadband wireless communication nunit does not satisfy the data QoS policy of the broadband wireless communication unit, the transmit power of the broadband wireless communication unit is reduced stepwise while the data QoS policy of the broadband wireless communication unit is satisfied.

21. The method of claim 17, wherein the set channel is maintained until before at least one of an event in which the broadband wireless communication network performs handover or controls the transmit power, an event in which a channel of the local area wireless communication network is changed or the transmit power is controlled, and a periodical interrupt check event by a watch dog timer occurs.

22. The method of claim 17, wherein if the data packet error rate of the broadband wireless communication unit is larger than a particular reference value, a valid channel which is not in use by other terminals is searched from among a plurality of local area wireless communication channels and set.

23. The method of claim 22, wherein if there is no valid channel, the process of reducing the transmit power of the local area wireless communication unit is repeatedly performed until the transmit power of the broadband wireless communication unit becomes smaller than that of the local area wireless communication unit or until a data QoS policy of the broadband wireless communication unit is not satisfied, and
If the data packet error rate of the broadband wireless communication unit becomes smaller than the particular reference value, wireless communication is performed with the set transmit power of the local area wireless communication unit.

24. The device of claim 17, wherein if the data error rate of the local area wireless communication unit is still larger than the particular reference value even after the transmit power is reduced until the data QoS policy of the broadband wireless communication unit is not satisfied, the local area wireless communication unit cannot be used.

25. The device of claim 17, wherein as the local area wireless communication channel, a channel having a low frequency is preferentially searched, and when a channel is changed, a capability negotiation about the channel is performed.
